(19) United States
(12) Patent Application Publication
(10) Pub. No.: US 2012/0193182 A1
(43) Pub. Date: Aug. 2, 2012

(54) STATOR TABS FOR STAKING

(75) Inventor: Nigel Gurney, Wooster, OH (US)

(73) Assignee: Schaeffler Technologies AG & CO. KG, Herzogenaurach (DE)

(21) Appl. No.: 13/362,603

(22) Filed: Jan. 31, 2012

Related U.S. Application Data
(60) Provisional application No. 61/437,923, filed on Jan. 31, 2011.

(51) Int. Cl. F16D 41/06; B23P 19/00; B23P 11/00

(52) U.S. Cl. 192/46; 29/428; 29/700

(57) ABSTRACT

A stator assembly including a stator body having an axially outer surface, wherein at least one raised pod extends axially from the axially outer surface in a first axial direction, a side plate substantially engaged with an inner diameter of the stator body for holding a one-way clutch assembly within the stator body, wherein the side plate is at least partially located axially within stator body, wherein the at least one raised pod is operatively arranged to be compressed in a second axial direction, the second axial direction opposite to the first axial direction, and wherein compressing the at least one raised pod deforms the at least one raised pod to extend radially to form at least one radial tab, wherein the at least one radial tab overlaps the side plate for securing the stator body and the side plate together.

### CROSS-REFERENCE TO RELATED APPLICATIONS

This application claims the benefit under 35 U.S.C. §119(e) of U.S. Provisional Patent Application No. 61/437,923 filed Jan. 31, 2011, which application is incorporated herein by reference.

### FIELD OF THE INVENTION

The invention broadly relates to torque converters, more specifically to stator assemblies for torque converters, and even more particularly to axially raised pods on a stator body for staking to secure a side plate.

### BACKGROUND OF THE INVENTION

Torque converters are well known in the art including stator assemblies for redirecting the flow of fluid exiting the turbine before it is reintroduced to the impeller, as the impeller and turbine direct the fluid in opposite directions during normal operation of the torque converter. Under some circumstances, the impeller and turbine are spinning such that the fluid entering the impeller from the turbine is already spinning in the proper direction. Under these conditions, the stator would only undesirably slow down the fluid if it was not allowed to spin. Accordingly, the stator is fixed against rotation in one direction and able to free-wheel in the other direction by use of a one-way clutch. In this way, the stator is free to spin in the event the fluid is already traveling in the same direction as the impeller, and otherwise is locked against rotation in order to turn the direction of the fluid before it reenters the impeller.

Typically, a side plate is included in the stator assembly in order to lock the components of the one-way clutch within the main stator body. The stator body is typically staked at locations around the outer diameter of the side plate in order to create radially inward projections for axially locking the side plate to the stator body. However, before staking, the axial surface of the stator body forms a continuous axial surface, either as a flat surface or as an annular raised ring. As a result, the portions of the stator body that are not staked are still at the same axial position and the stator body has the same outermost axial width or thickness both before and after staking.

### BRIEF SUMMARY OF THE INVENTION

The present invention broadly comprises an assembly for securing two components together including a first component having an axially outer surface, wherein at least one raised pod extends axially from the axially outer surface in a first axial direction, a second component substantially engaged with a diameter of the first component and at least partially located axially within first component, wherein the at least one raised pod is operatively arranged to be compressed in a second axial direction, the second axial direction opposite to the first axial direction, and wherein compressing the at least one raised pod deforms the at least one raised pod to extend radially to form at least one radial tab, wherein the at least one radial tab overlaps the second component for securing the first and second components together.

In one embodiment, the diameter is an inner diameter of the first component and the at least one radial tab extends radially inward. In one embodiment, before compressing the at least one raised pod, an axially outermost portion of the first component is defined by a first distance between the at least one raised pod and the outer axial surface of the first component, and wherein after compressing the at least one raised pod, the axially outermost portion is shifted axially toward the axially outer surface in the second axial direction by a second axial distance, wherein the second axial distance is less than or equal to the first distance and greater than zero. In one embodiment, the at least one raised pod comprises a plurality of raised pods spaced evenly about the diameter.

The current invention also broadly comprises: a process for securing two components together including (a) providing a first component, the first component having at least one raised pod about a diameter of the first component, wherein the at least one raised pod is a discrete portion of the first component that extends axially from an outer axial surface of the first component, (b) providing a second component engaged with the diameter, and wherein the at least one raised pod extends axially past the second component, (c) compressing the at least one raised pod in order to form a radially extending tab, wherein the radially extending tab radially overlaps the second component for axially locking the second component to the first component. In one embodiment, the diameter is an inner diameter of the first component and the at least one radial tab extends radially inward.

In one embodiment, before step (c), an axially outermost portion of the first component is defined by a first distance between the at least one raised pod and the outer axial surface of the first component, and wherein after step (c), the axially outermost portion is shifted axially toward the axially outer surface in the second axial direction by a second axial distance, wherein the second axial distance is less than or equal to the first distance and greater than zero. In one embodiment, the at least one raised pod comprises a plurality of raised pods spaced evenly about the diameter. In one embodiment, the at least one raised pod comprises a plurality of raised pods and all of the raised pods are compressed simultaneously in step (c).

The current invention also broadly comprises a stator assembly including a stator body having an axially outer surface, wherein at least one raised pod extends axially from the axially outer surface in a first axial direction, a side plate substantially engaged with an inner diameter of the stator body for holding a one-way clutch assembly within the stator body, wherein the side plate is at least partially located axially within stator body, wherein the at least one raised pod is operatively arranged to be compressed in a second axial direction, the second axial direction opposite to the first axial direction, and wherein compressing the at least one raised pod deforms the at least one raised pod to extend radially to form at least one radial tab, wherein the at least one radial tab overlaps the side plate for securing the stator body and the side plate together.

In one embodiment, the diameter is an inner diameter of the stator body and the at least one radial tab extends radially inward. In one embodiment, before compressing the at least one raised pod, an axially outermost portion of the stator body is defined by a first distance between the at least one raised pod and the outer axial surface of the stator body, and wherein after compressing the at least one raised pod, the axially outermost portion is shifted axially toward the axially outer surface in the second axial direction by a second axial distance, wherein the second axial distance is less than or equal to the first distance and greater than zero. In one embodiment, the at least one raised pod comprises a plurality of raised pods spaced evenly about the diameter. In one embodiment, the at least one raised pod spans approximately five to ten degrees of rotation about the diameter. In one embodiment, the first distance is approximately 1 mm to 3 mm and the second distance is approximately 0.5 mm to 1.5 mm.

### BRIEF DESCRIPTION OF THE DRAWINGS

The nature and mode of operation of the present invention will now be more fully described in the following detailed description of the invention taken with the accompanying drawing figures, in which:

FIG. 1 is an exploded perspective view of a stator assembly;

FIG. 2 is a view of a first axial side of the stator assembly of FIG. 1;

FIG. 3 is a view a second axial side of the stator assembly of FIG. 2;

FIG. 4 is a cross-sectional view of the stator body of the stator assembly taken generally along line A-A in FIG. 3, before staking;

FIG. 5 is a perspective view of the stator body of the stator assembly taken generally along line B-B in FIG. 3, before staking;

FIG. 6 is a cross-sectional view of the stator assembly taken generally along line A-A in FIG. 3, after staking; and,

FIG. 7 is a perspective view of the stator assembly taken generally along line B-B in FIG. 3, after staking.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

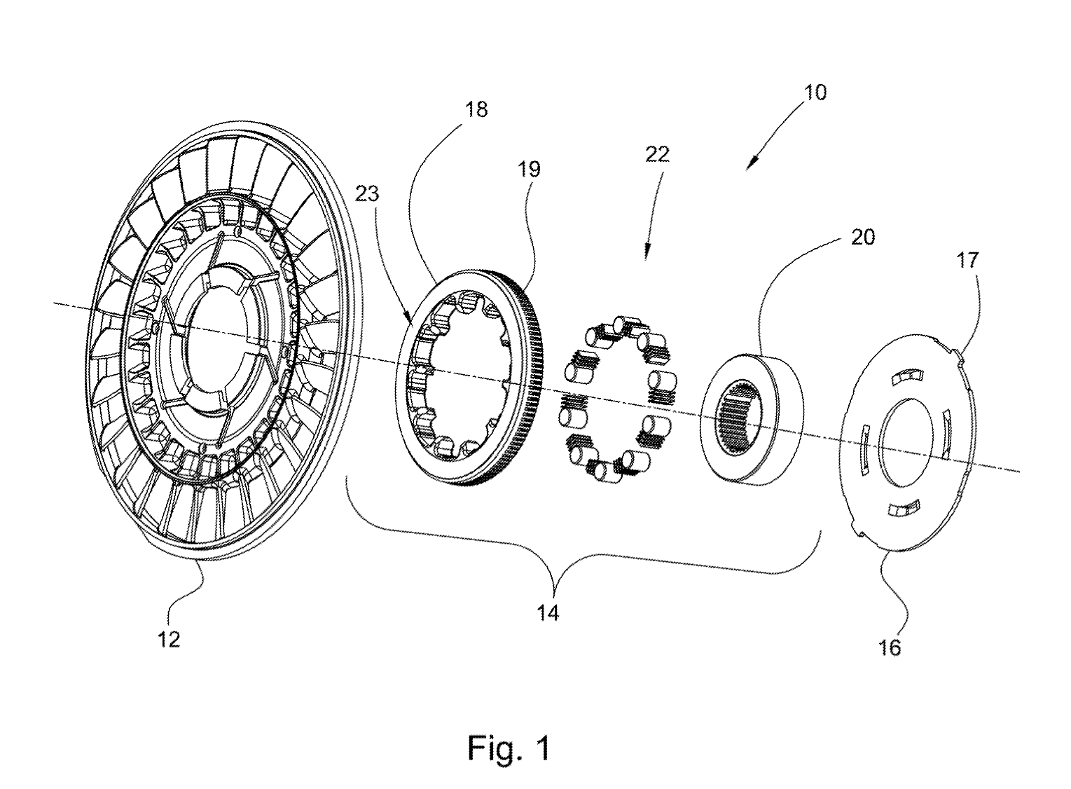

Referring now to the figures, FIG. 1 shows stator assembly 10. Stator assembly 10 includes stator body 12, which includes a plurality of blades for redirecting the flow of fluid in a torque converter as it transfers from the turbine to the impeller. The stator body is typically formed as a single die-cast piece. Stator body 12 is coupled with one-way clutch assembly 14, which assembly is held in place by side plate 16. One way-clutch assembly 14 is included in order to lock the stator rotationally in one direction, while enabling the stator to free-wheel in the other direction. Such one-way clutch assemblies are well known in the art, and while one example is given herein, it should be appreciated that other arrangements are also possible which include a plate similar to side plate 16 that can be staked to the stator body in order to keep the one-way clutch components within the stator body. Tabs 17 of side plate 16 may fit into corresponding slots in stator body 12 to prevent rotation of the side plate relative to the stator body. To assemble the one-way clutch, outer race 18 of the free-wheel assembly is pressed into stator body 12 so as to lock the outer race rotationally to the stator body. For example, outer race 18 may include ridges 19 to assist in pressing the outer race into the stator body. Inner race 20 and free-wheel components 22 are not rotationally secured to the stator body in order to enable the stator body to free-wheel in one direction, and might simply fall axially out of the stator body if side plate 16 was not included. The inner race is splined for non-rotational connection to a stator shaft from the vehicle's transmission (shaft not shown). Free-wheel components 22 comprise, for example, alternating sets of springs and rollers which operate in connection with tapered sections 23 of outer race 18, which sections which have staggered smaller and larger diameter portions in order to create the one-way clutch operation for stator assembly 10 when operated with components 22.

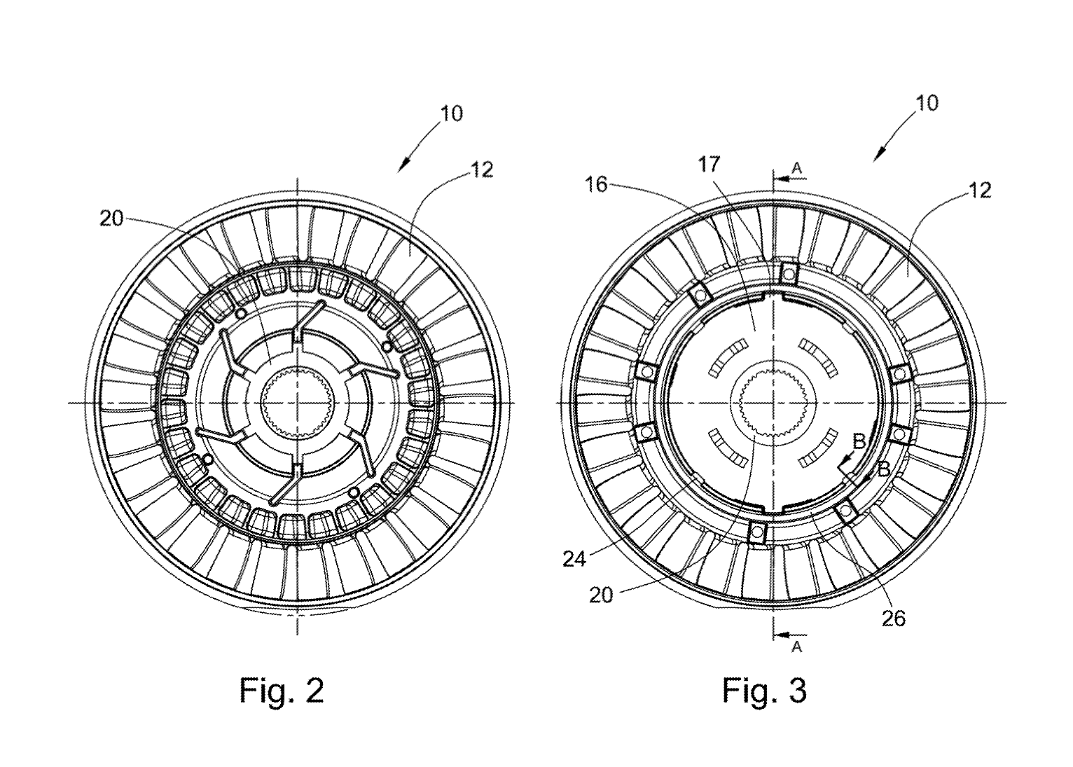

FIGS. 2 and 3 show first and second axial sides of stator assembly 10, respectively. From the first axial side, primarily only stator body 12 can be seen with inner race 20 positioned radially inside of the stator body. In FIG. 3, side plate 16 is shown holding in the one-way clutch assembly. Tabs 17 on the side plate are included resting in corresponding slots in the stator body to prevent rotation of the side plate relative to the stator body. Axially raised pods 24 are included evenly spaced at four locations about axial surface 26 of stator body 12, which raised pods are staked, or axially compressed, in order to lock side plate 16 to stator body 12, as described in more detail below. It should be appreciated that any number of raised pods could be included about the inner diameter of the stator body.

Axial surface 26 is considered to be an axially outer surface of the stator body, and what is further meant by axially outer surface is that it is the outermost axial surface of the stator body, with the exception of raised pods 24, which are formed as discrete raised portions that extend axially from surface 26. In other words, outer axial surface 26 would be the outermost surface of the stator body if the raised pods 24 were not included. Briefly, according to the current invention, it has been found that axial space savings are possible by axially raising only those specific portions of the stator body that are going to be staked, because these portions are compressed during the staking process.

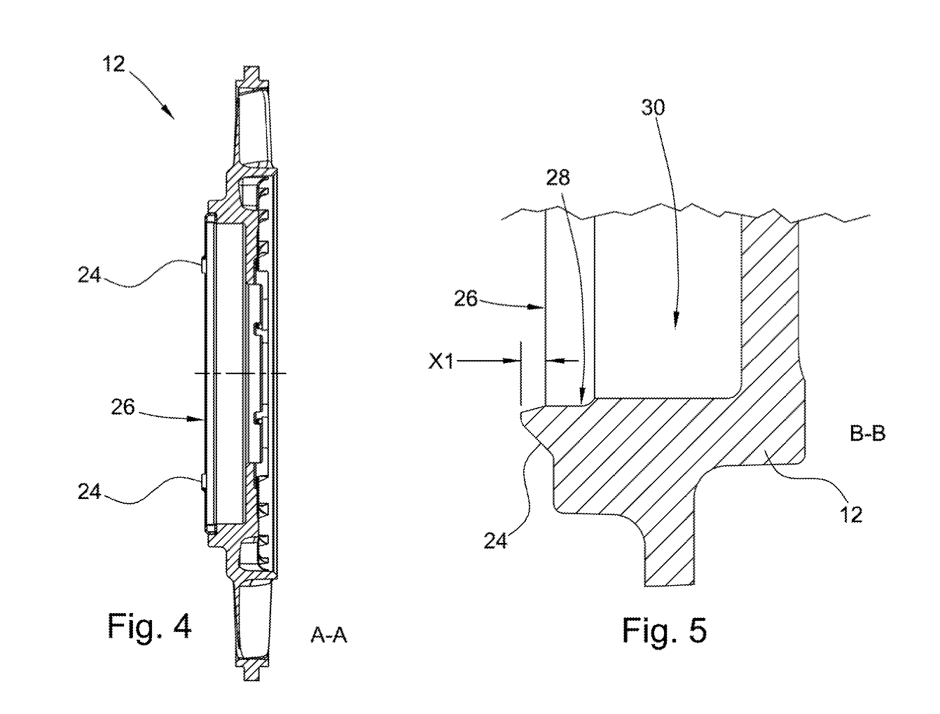

Cross-sections of stator body 12 of stator assembly 10 taken along line A-A and B-B of FIG. 3 is shown in FIGS. 4 and 5, respectively. That is, stator body 12 is shown in FIGS. 4 and 5 without the other components of assembly 10. Furthermore, stator body 12 in FIGS. 4 and 5 is shown before pods 24 have been staked, or compressed axially. It can be seen that raised pods 24 protrude axially at discrete locations from axial surface 26 of stator body 12. Specifically, as shown in FIG. 5, raised pods 24 protrude from axial surface 26 a distance designated as distance X1. The stator body is also shown having inner diameter 28 and receiving section 30 for receiving side plate 16 and outer race 18, respectively. When assembled with the stator body, outer race 18 and inner race 20 are considered to be axially and radially within the stator body. By axially or radially within, it is generally meant at a position that is within the axial or radial boundaries of the stator body. In other words, by axially or radially within, it means that the component does not extend axially or radially past the stator body.

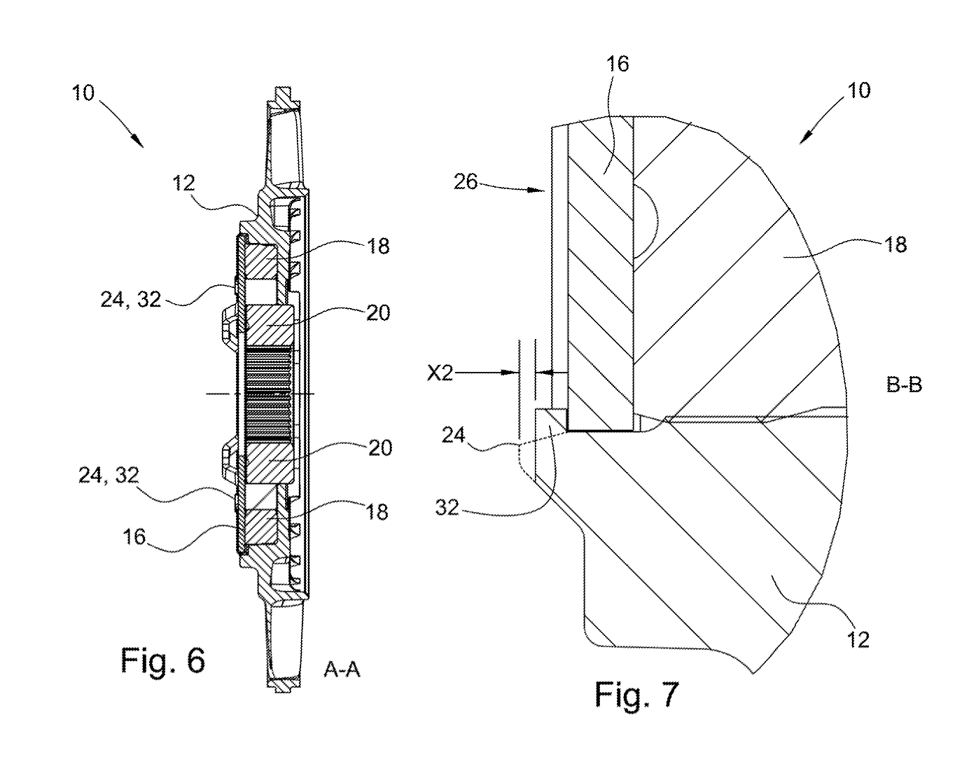

Like FIGS. 4 and 5, cross-sections of stator assembly 10 taken along line A-A and B-B of FIG. 3 are shown in FIGS. 6 and 7, respectively. That is, stator assembly 10 is shown in its fully assembled state in FIGS. 6 and 7, with outer race 18 pressed into stator body 12, and inner race 20 held within the stator body by side plate 16 (one-way clutch components 22 would be held in the space between the inner and outer races). Furthermore, raised pods 24 are shown after they have been staked, or compressed axially, with the original orientation of raised pods 24 shown in dashed lines.

Accordingly, it can be seen that raised pods 24 have been compressed by a distance designated as distance X2 from their original layout. By axially compressing the pods, the material of the stator body is deformed such that tabs 32 are formed, which radial tabs extend radially inward from the stator body to radially overlap the side plate, thereby locking the side plate axially to the stator body. The raised pods project axially from axial surface 26 by a distance equal to the original axial height of the pods (distance X1) minus the compressed distance (distance X2). In some embodiments, this may result in pods 24 and/or tabs 32 being flush with surface 26, or slightly axially misaligned from surface 26, as shown. That is, initially, the axially outermost position is defined at a distance X1 from axially outer surface 26, and this axially outermost position is shifted by a distance X2 towards axially outer surface 26. Since surface 26 is not compressed, then the most that the axially outermost portion of the stator body would be shifted is equal to distance X1 (i.e., even if the raised pods were compressed axially within surface 26, surface 26 would then become the axially outermost surface). In any event, axial clearance is created, as shown by distance X2, with 0<X2≦X1. That is, in prior art systems, the axial surface corresponding to surface 26 would be located axially in line with the height of pods 24 (before staking), such that even if portions of this prior art surface were staked, the remainder of the surface would still be taking up necessary axial space and protruding past the staked portions. It is not practical to stake the entire axial surface, as this either would require an extreme amount of force to compress this much material simultaneously, or too much time to run multiple compressions, and would likely result in deformation of the stator body, which is not permissible, because the outer race would not fit properly, causing the one-way clutch to fail.

In embodiments for stators of typical automobiles, the raised pods are approximately 6 mm long in the circumferential direction, have an axial height of approximately 1 mm to 3 mm, are approximately 2 mm-5 mm wide in the radial direction at the axially outermost portion top (with a tapering towards the bottom), and are compressed a distance of approximately 0.5 mm to 1.5 mm (e.g., distance X2 equals 0.5 mm-1.5 mm approximately), while the inner diameter of the stator body is approximately 90 mm-100 mm. Thus, in the embodiments shown in the Figures, each raised pod spans approximately 5-10 degrees of rotation about inner diameter with which the side plate is engaged. If larger or smaller stators are used, however, it should be appreciated that the size and amount of compression of the pods would likely also increase or decrease, respectively.

Due to the ever increasing demand for higher performance and smaller sized torque converters, even small axial savings can result in significant and meaningful improvements in materials costs, tolerances, size, performance, etc. For example, this small axial savings could enable the same performance as a prior art torque converter at a smaller size, or enable the use of a larger damper assembly, for example, resulting in improved performance at the same size as prior art systems. As another example, there are material cost savings in the casting of the stator body, because only those portions that are staked are axially raised, thereby reducing the axial thickness of the stator body (e.g., the width or thickness in the axial direction of stator 12, with respect to surface 26, can be made thinner than prior art systems, thereby saving material). The use of raised tabs may also enable simplified staking tooling, and the axial clearance may result in further simplification of the design of adjacent components.

It should also be appreciated that the stator body and side plate generically represent any two components that can be staked together to prevent axial movement between the components. Thus, the current invention could be used as described above for staking any two components together in the axial direction. Furthermore, it should be appreciated that instead of providing raised pods around an inner diameter of a first component (as shown with respect to pods 24 on the inner diameter of stator body 12), the pods could be formed in a similar manner as described above about an outer diameter of a first component for securing to a second component located radially outwards from the raised pods.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A stator assembly comprising:
a stator body having an axially outer surface, wherein at least one raised pod extends axially from said axially outer surface in a first axial direction;
a side plate substantially engaged with an inner diameter of said stator body for holding a one-way clutch assembly within said stator body, wherein said side plate is at least partially located axially within stator body;
wherein said at least one raised pod is operatively arranged to be compressed in a second axial direction, said second axial direction opposite to said first axial direction, and wherein compressing said at least one raised pod deforms said at least one raised pod to extend radially to form at least one radial tab, wherein said at least one radial tab overlaps said side plate for securing said stator body and said side plate together.

2. The stator assembly recited in claim 1, wherein said diameter is an inner diameter of said stator body and said at least one radial tab extends radially inward.

3. The stator assembly recited in claim 1, wherein before compressing said at least one raised pod, an axially outermost portion of said stator body is defined by a first distance between said at least one raised pod and said outer axial surface of said stator body, and wherein after compressing said at least one raised pod, said axially outermost portion is shifted axially toward said axially outer surface in said second axial direction by a second axial distance, wherein said second axial distance is less than or equal to said first distance and greater than zero.

4. The stator assembly recited in claim 1, wherein said at least one raised pod comprises a plurality of raised pods spaced evenly about said diameter.

5. The stator assembly recited in claim 1, wherein said at least one raised pod spans approximately five to ten degrees of rotation about said diameter.

6. The stator assembly recited in claim 1, wherein said first distance is approximately 1 mm to 3 mm and said second distance is approximately 0.5 mm to 1.5 mm.

7. An assembly for securing two components together comprising:
a first component having an axially outer surface, wherein at least one raised pod extends axially from said axially outer surface in a first axial direction;
a second component substantially engaged with a diameter of said first component and at least partially located axially within first component;
wherein said at least one raised pod is operatively arranged to be compressed in a second axial direction, said second axial direction opposite to said first axial direction, and wherein compressing said at least one raised pod deforms said at least one raised pod to extend radially to form at least one radial tab, wherein said at least one radial tab overlaps said second component for securing said first and second components together.

8. The assembly recited in claim 7, wherein said diameter is an inner diameter of said first component and said at least one radial tab extends radially inward.

9. The assembly recited in claim 7, wherein before compressing said at least one raised pod, an axially outermost portion of said first component is defined by a first distance between said at least one raised pod and said outer axial surface of said first component, and wherein after compressing said at least one raised pod, said axially outermost portion is shifted axially toward said axially outer surface in said second axial direction by a second axial distance, wherein said second axial distance is less than or equal to said first distance and greater than zero.

10. The assembly recited in claim 7, wherein said at least one raised pod comprises a plurality of raised pods spaced evenly about said diameter.

11. A process for securing two components together comprising:
(a) providing a first component, said first component having at least one raised pod about a diameter of said first component, wherein said at least one raised pod is a discrete portion of said first component that extends axially from an outer axial surface of said first component;
(b) providing a second component engaged with said diameter, and wherein said at least one raised pod extends axially past said second component;
(c) compressing said at least one raised pod in order to form a radially extending tab, wherein said radially extending tab radially overlaps said second component for axially locking said second component to said first component.

12. The method recited in claim 10, wherein said diameter is an inner diameter of said first component and said at least one radial tab extends radially inward.

13. The method recited in claim 10, wherein before step (c), an axially outermost portion of said first component is defined by a first distance between said at least one raised pod and said outer axial surface of said first component, and wherein after step (c), said axially outermost portion is shifted axially toward said axially outer surface in said second axial direction by a second axial distance, wherein said second axial distance is less than or equal to said first distance and greater than zero.

14. The method recited in claim 10, wherein said at least one raised pod comprises a plurality of raised pods spaced evenly about said diameter.

15. The method recited in claim 10, wherein said at least one raised pod comprises a plurality of raised pods and all of said raised pods are compressed simultaneously in step (c).
